(19) United States
(12) Patent Application Publication
(10) Pub. No.: US 2020/0274211 A1
(43) Pub. Date: Aug. 27, 2020

(54) BATTERY AND BATTERY PACK

(71) Applicant: Dongguan Amperex Technology Limited, Dongguan (CN)

(72) Inventors: Yi Li, Dongguan (CN); Xiaoming Chen, Dongguan (CN)

(21) Appl. No.: 16/413,647

(22) Filed: May 16, 2019

(30) Foreign Application Priority Data
Feb. 27, 2019 (CN) 201920248840.8

(51) Int. Cl. H01M 10/653; H01M 10/647; H01M 10/613; H01M 10/6551; H01M 10/6554; H01M 10/04; H01M 2/10

(52) U.S. Cl. CPC H01M 10/653; H01M 10/647; H01M 10/613; H01M 2/1077; H01M 10/6554; H01M 10/0413; H01M 10/6551

(57) ABSTRACT

The present application discloses a battery and a battery pack, and the battery includes a plurality of cells arranged in a stack, a plurality of first thermally conductive components arranged on surfaces of each cell, a second thermally conductive component constituting a portion of the surface of the battery, and each of the plurality of first thermally conductive components contacting the second thermally conductive component. The battery provided by the above technical solution of the present application may at least achieve balanced temperature between the plurality of the cells of the battery, thereby improving the life of the battery.

### CROSS-REFERENCE TO RELATED APPLICATIONS

The present application claims priority to Chinese Patent Application No. 201920248840.8, filed on Feb. 27, 2019, the content of which is incorporated herein by reference in its entirety.

### FIELD OF THE APPLICATION

The present application relates to the technical field of battery, in particular, to a battery and a battery pack.

### BACKGROUND OF THE APPLICATION

FIG. 1 shows a structural view of a conventional battery pack. As shown in FIG. 1, the battery pack 100 generally includes a plurality of cells 110 disposed in a stack way, and a heat dissipating sheet 120 disposed on the surface of each cell 110 to achieve heat dissipation for the respective cell 110. Generally, there may be a dozen or dozens of stacked cells in the battery pack. Due to the heat build-up of the cells located at the center of the battery pack, the temperature difference between the cell located at the center and the cell located at the edge is large, which affects the life of the cell. In addition, a dozen or even dozens of cell stacked together may cause assembly for battery pack to be difficult.

### SUMMARY OF THE APPLICATION

The present application proposes a battery and a battery pack for the above problems in the related art, which may at least reduce the temperature difference between the cell at the center and the cell at the edge of the battery, thereby improving the life of the cell.

The technical solution of the present application is implemented as follows:

According to an aspect of the present application, a battery is provided, including: a plurality of cells arranged in a stack; a plurality of first thermally conductive components arranged on a surface of each cell; and a second thermally conductive component constituting a portion of the surface of the battery, and each of the plurality of first thermally conductive components contacting the second thermally conductive component.

According to an embodiment of the present application, the second thermally conductive component is U-shaped the second thermally conductive component constitutes at least a portion of a first surface, a second surface, and at least a portion of a third surface of the battery, and the first surface, the second surface, and the third surface are sequentially connected to each other.

According to an embodiment of the present application, the second thermally conductive component includes a first thermally conductive sub-component and a second thermally conductive sub-component, and the first thermally conductive sub-component and the second thermally conductive sub-component are L-shaped; and the first thermally conductive sub-component constitutes the first surface and a first portion of the second surface of the battery, and the second thermally conductive sub-component constitutes a second portion of the second surface and the third surface of the battery.

According to an embodiment of the present application, wherein the sum of areas of the first portion of the second surface and the second portion of the second surface is greater than or equal to 90% of an area of the second surface.

According to an embodiment of the present application, wherein at least one of the first thermally conductive components is U-shaped, and located at least a portion of the first surface, the second surface, and at least a portion of the third surface of the respective cell, and the first surface, the second surface, and the third surface of the cell are sequentially connected to each other.

According to an embodiment of the present application, wherein two of the plurality of first thermally conductive components are respectively arranged on surfaces of adjacent two of the plurality of cells, and the two of the plurality of first thermally conductive components are arranged opposed to each other and are snapped each other.

According to an embodiment of the present application, the battery further includes a thermally conductive adhesive arranged between the second thermally conductive component and each of the plurality of first thermally conductive components.

According to an embodiment of the present application, edges of the plurality of first thermally conductive components are aligned with each other in a length direction of the cell.

According to an embodiment of the present application, the battery further includes a buffer sheet located between adjacent two of the plurality of cells.

According to another aspect of the present application, a battery pack is provided, including a plurality of batteries and a third thermally conductive component, each battery including a plurality of cells arranged in a stack; a plurality of first thermally conductive components arranged on a surface of each cell; and a second thermally conductive component constituting a portion of the surface of the battery, and each of the plurality of first thermally conductive components contacting the second thermally conductive component; wherein the third thermally conductive component contacts the second thermally conductive component. According to another aspect of the present application, the battery pack further comprises a second thermally conductive adhesive arranged between the third thermally conductive component and the second thermally conductive component.

According to another aspect of the present application, the plurality of batteries are stacked in a thickness direction of the battery.

According to another aspect of the present application, the third thermally conductive component is U-shaped, and the third thermally conductive component constitutes at least a portion of a first side surface, a second side surface, and at least a portion of a third side surface of the battery pack, wherein the first side surface, the second side surface, and the third side surface are sequentially connected to each other.

According to another aspect of the present application, the battery pack further includes a second buffer sheet located between adjacent two of the plurality of batteries.

According to another aspect of the present application, the plurality of batteries is divided into a first battery and a second battery, and the first battery is at a side within the battery pack; the first battery includes a plurality of first cells, and the second battery includes a plurality of second cells, wherein the number of the plurality of first cells is different from the number of the plurality of second cells.

According to another aspect of the present application, the second thermally conductive component is U-shaped, and the second thermally conductive component constitutes at least a portion of a first surface, a second surface, and at least a portion of a third surface of the battery, wherein the first surface, the second surface, and the third surface are sequentially connected to each other.

According to another aspect of the present application, the second thermally conductive component includes a first thermally conductive sub-component and a second thermally conductive sub-component, the first thermally conductive sub-component and the second thermally conductive sub-component are both L-shaped; the first thermally conductive sub-component constitutes the first surface and a first portion of the second surface of the battery, and the second thermally conductive sub-component constitutes a second portion of the second surface and the third surface of the battery.

According to another aspect of the present application, the sum of areas of the first portion of the second surface and the second portion of the second surface is greater than or equal to 90% of an area of the second surface.

According to another aspect of the present application, at least one of the plurality of first thermally conductive components is U-shaped and located at least a portion of the first surface, the second surface, and at least a portion of the third surface of the respective cell, wherein the first surface, the second surface, and the third surface of the cell are sequentially connected to each other.

According to another aspect of the present application, two of the first thermally conductive components are respectively arranged on surfaces of two adjacent ones of the cell, and the two of the first thermally conductive components are arranged as opposite to each other and are snapped each other.

The beneficial effects of the present application are as follows:

For the battery provided by above technical solution of the present application, since each of the first thermally conductive components is in contact with the second thermally conductive component, the heat conduction between the cell at the edge and the cell at the center may be achieved by the first thermally conductive component and the second thermally conductive component, so as to reduce the heat concentration effect at the center of the battery when working and reduce the temperature difference between the cell at the center and the cell at the edge, thereby improving the life of the cell.

For the battery pack provided by above technical solution of the present application, the heat conduction between the cell at the edge of the battery pack and the cell at the center of the battery pack may be achieved by the heat transfer among the first thermally conductive components, the second thermally conductive component and the third thermally conductive component, so as to reduce the heat concentration effect at the center of the battery pack when working and reduce the temperature difference between the cell at the center and the cell at the edge, causing the temperature between multiple cells in the battery pack more balanced, thereby improving the life of the battery pack. On the other hand, when the battery pack is assembled, it can be assembled in units of each battery. Therefore, the battery pack provided by the present application is more convenient to assemble, and may avoid the problem that assembly and movement are difficult due to the battery pack being too heavy during the assembly process.

### BRIEF DESCRIPTION OF THE ACCOMPANYING DRAWINGS

In order to illustrate embodiments of the present disclosure or technical schemes in the prior art more clearly, the drawings which are required to be used in the description of the embodiments of the present disclosure are briefly described below. It is obvious that the drawings described below are only some embodiments of the present disclosure. It is apparent to those of ordinary skill in the art that other drawings may be obtained based on the structures shown in accompanying drawings without inventive effort.

FIG. 1 is a structural view of a conventional battery pack;

FIG. 2 is a structural view of the battery according to an embodiment of the present application;

FIG. 3 is an exploded view of the battery according to an embodiment of the present application;

FIG. 4a is a front view of the second thermally conductive component of the battery according to an embodiment of the present application;

FIG. 4b is a side view of the second thermally conductive component of the battery according to an embodiment of the present application;

FIG. 5 is a front view of the second thermally conductive component of the battery according to another embodiment of the present application;

FIG. 6 is a front view of the battery comprising the second thermally conductive component of FIG. 5;

FIG. 7a is a front view of the first thermally conductive component of the battery according to an embodiment of the present application;

FIG. 7b is a side view of the first thermally conductive component of the battery according to an embodiment of the present application;

FIG. 8a is a structural view of the first thermally conductive component of the battery according to another embodiment of the present application;

FIG. 8b is an exploded view of the first thermally conductive component of FIG. 8a;

FIG. 9 is a structural view of the battery pack according to an embodiment of the present application;

FIG. 10 is an exploded view of the plurality of batteries of the battery pack according to an embodiment of the present application.

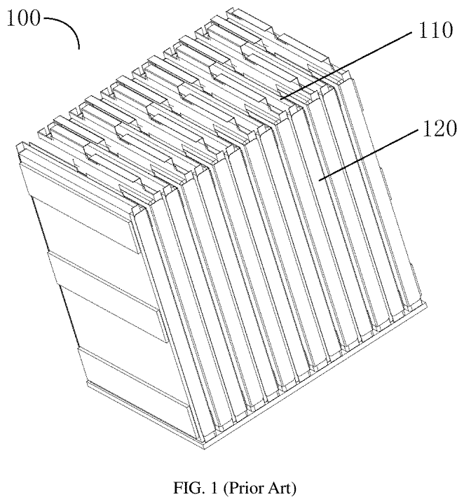

### DETAILED DESCRIPTION OF THE PREFERRED EMBODIMENTS

The technical schemes of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present disclosure without creative efforts shall fall within the protection scope of the present disclosure. Based on the embodiments of the present application, all the other embodiments obtained by those of ordinary skill in the art are within the scope of the present application.

The respective exemplary embodiments in the following description and in the drawings may be combined with each other to form other embodiments not described below; and some of the components may be omitted in different embodiments. In other words, the following description does not limit the present application.

FIG. 2 shows a structural view of the battery according to an embodiment of the present application. The present application provides a battery 10, and the battery 10 includes a plurality of cells 12 stacked arranged. The number of cells 12 shown in FIG. 2 is merely exemplary and the cells 12 may be any other suitable number.

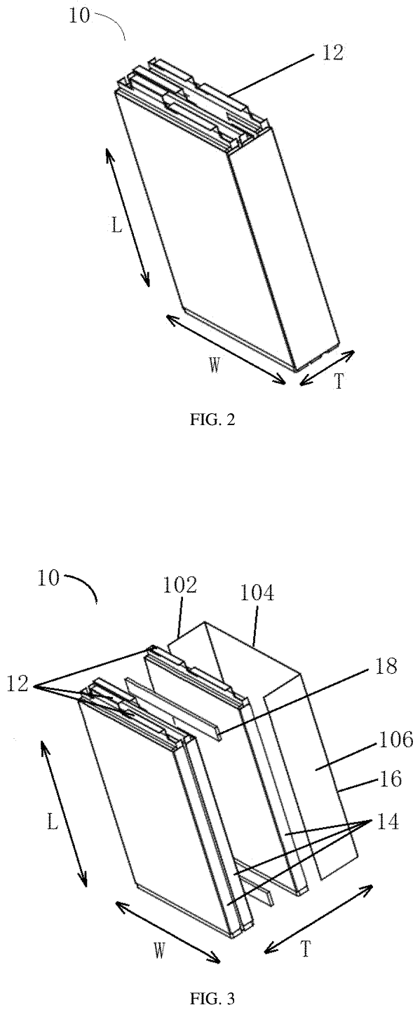

FIG. 3 shows an exploded view of the battery according to an embodiment of the present application. As shown in FIG. 3, the battery 10 of the present application may further include a plurality of first thermally conductive components 14 and a second thermally conductive component 16. The plurality of first thermally conductive components 14 are respectively disposed on the surface of each of the cells 12. The second thermally conductive component 16 constitutes a portion of a surface of the battery 10, and each of the first thermally conductive components 14 is in contact with the second thermally conductive component 16. Thus, the heat conduction between the plurality of cells 12 may be achieved by the plurality of first thermally conductive components 14 and the second thermally conductive component 16. In some embodiments, the plurality of cells 12 are stacked in a thickness direction T of each of the cells 12. The second thermally conductive component 16 shown in FIG. 3 is configured as a first side surface 102 in which the battery 10 extends in the thickness direction T of each of the cells 12, a surface 104 extending in a width direction W, and a second side surface 106 opposite to the first side surface 102. It should be understood that other suitable designs of the structure and dimensions of the second thermally conductive component 16 may be made such that the second thermally conductive component 16 forms other portions of the surfaces of the battery 10, which is not limited in this application.

For the battery 10 provided by above technical solution of the present application, since the first thermally conductive components 14 on the surface of each cell is in contact with the second thermally conductive component 16, the heat conduction between the cell 12 at the edge and the cell 12 at the center may be achieved by the first thermally conductive components 14 and the second thermally conductive component 16, so as to reduce the heat concentration effect at the center of the battery when working and reduce the temperature difference between the cell 12 at the center and the cell 12 at the edge, causing the temperature between the plurality of cells 12 of the battery 10 more balanced, thereby improving the life of the cell.

The first thermally conductive component 14 and the second thermally conductive component 16 may take any suitable material having thermal conductivity. In an embodiment, the materials of the first thermally conductive component 14 and the second thermally conductive component 16 are both aluminum. In an embodiment, the materials of the first thermally conductive component 14 and the second thermally conductive component 16 may be different.

With continued reference to FIG. 3, the battery 10 of the present application may further include a buffer sheet 18, and the buffer sheet 18 is between adjacent two of the plurality of cells 12 to connect the adjacent two cells 12. The cell 12 and the buffer sheet 18 may be fixedly connected by providing an adhesive on the buffer sheet 18. The buffer sheet 18 may be a material having a cushioning effect such as foam and so on. The connection between the cells 12 is achieved by providing the buffer sheet 18 between the adjacent two cells 12, and an expansion space may be reserved for each of the cells.

In an embodiment, the battery 10 may further include a thermally conductive adhesive disposed between the second thermally conductive component 16 and each first thermally conductive component 14. In an embodiment, the material of the thermally conductive adhesive is thermal grease. In some embodiments, the material of the thermally conductive adhesive may also be other suitable thermally conductive materials. The transfer of heat between the first thermally conductive component 14 and the second thermally conductive component 16 may be achieved by filling the thermally conductive adhesive between the second thermally conductive component 16 and each of the first thermally conductive components 14. It should be understood that the connection and heat transfer between the first thermally conductive component 14 and the second thermally conductive component 16 may also be achieved by other suitable means.

In some embodiments, in a length direction L of each of the cells 12, the edges of the plurality of first thermally conductive components 14 may be aligned with each other. In some embodiments, the thickness of each first thermally conductive component 14 may be in the range of 0.2 mm to 0.5 mm, so that each first thermally conductive component 14 may have a proper thickness for achieving a good heat dissipation effect. In other embodiments, the first thermally conductive component 14 may have other suitable thicknesses depending on the actual application. In some embodiments, the first thermally conductive component 14 and the corresponding cell 12 may be joined by an adhesive. In some embodiments, the thickness of the adhesive may be in a range of 30 μm to 50 μm, e.g., 40 μm, thereby ensuring minimum conduction heat resistance and sufficient bonding strength on the heat transfer path. In an embodiment, the thickness of the second thermally conductive component 16 may be 0.2 mm. In other embodiments, the second thermally conductive component 16 may have other suitable thicknesses.

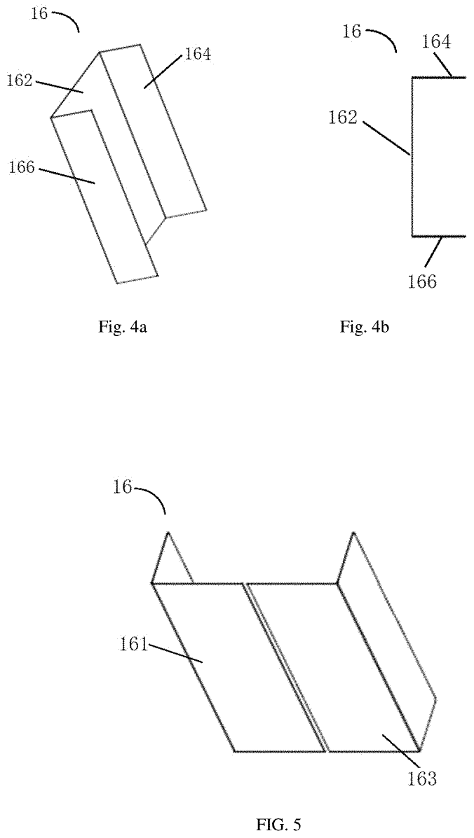

FIGS. 4a and 4b are a front view and a side view of the second thermally conductive component of the battery 10 according to an embodiment of the present application, respectively. In an embodiment, as shown in FIGS. 4A and 4b, the second thermally conductive component 16 is U-shaped. Specifically, the U-shaped second thermally conductive component 16 includes a bottom surface 162 and a first side wall 164 and a second side wall 166 that are connected to opposite ends of the bottom surface 162 and disposed opposite to each other. The U-shaped second thermally conductive component 16 constitutes at least a portion of a first surface, a second surface, and at least a portion of a third surface of the battery 10, and the first surface, the second surface, and the third surface are sequentially connected to each other. That is to say, the first sidewall 164 and the second sidewall 166 of the second thermally conductive component 16 respectively form at least a portion of the first surface and at least a portion of the third surface of the battery 10, and the bottom surface 162 of the second thermally conductive component 16 constitutes a second surface of the battery 10. By providing the second thermally conductive component 16 in a U-shaped configuration, the heat dissipation efficiency of the plurality of cells of the battery may be enhanced.

In an embodiment, as shown in FIG. 3, the first surface, the second surface, and the third surface of the battery 10 may be a first side surface 102 in which the battery 10 extends in the thickness direction T, a surface 104 extending in the width direction W, and a second side surface 106 opposite to the first side surface 102. That is to say, the U-shaped second thermally conductive component 16 constitutes the first side surface 102, the surface 104, and the second side surface 106. In other embodiments, the second thermally conductive component 16 may constitute other surfaces of the battery 10. In an embodiment, in the thickness direction T, the lengths of the first side wall 164 and the second side wall 166 of the second thermally conductive component 16 are the same as the thickness of the battery 10, so that the second thermally conductive component 16 may obtain a larger heat dissipation area.

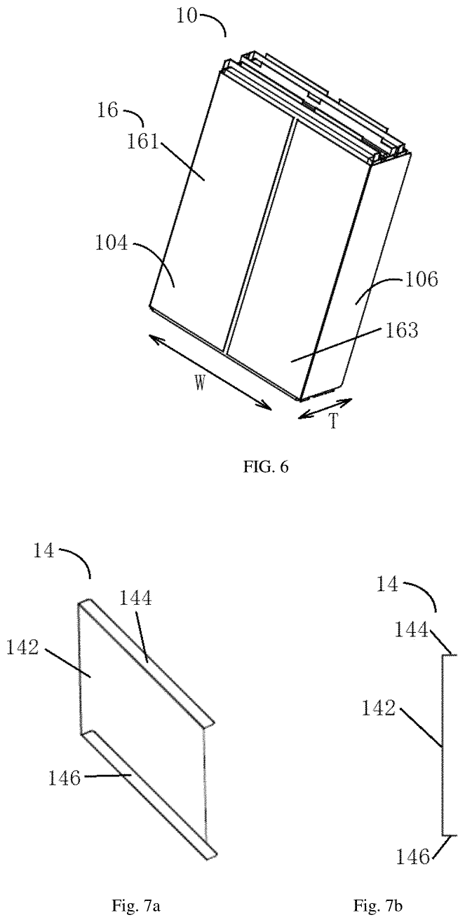

FIG. 5 shows a front view of the second thermally conductive component of the battery according to another embodiment of the present application. FIG. 6 shows a front view of the battery comprising the second thermally conductive component of FIG. 5. As shown in FIG. 5, the second thermally conductive component 16 may include a first thermally conductive sub-component 161 and a second thermally conductive sub-component 163, wherein the first thermally conductive sub-component 161 and the second thermally conductive sub-component 163 are both L-shape. As shown in FIG. 6, the first thermally conductive sub-component 161 constitutes the first surface and a first portion of the second surface of the battery 10, and the second thermally conductive sub-component 163 constitutes a second portion of the second surface and the third surface of the battery 10. In an embodiment, the first surface and the third surface may be the first side surface 102 and the second side surface 106 extending in the thickness direction T and disposed opposite to each other. The second surface may be the surface 104. That is to say, the second thermally conductive component 16 may constitute the first side surface 102 extending in the thickness direction T, the first and second portions of the surface 104 extending in the width direction W, and the second side surface 106 opposite to the first side surface.

In an embodiment, in order to obtain a sufficiently large heat transfer area, the sum of the areas of the first portion of the second surface and the second portion of the second surface is greater than or equal to 90% of the area of the second surface. That is to say, the second thermally conductive component 16 may constitute at least 90% of the surface area of the surface 104.

FIGS. 7a and 7b are a front view and a side view of the first thermally conductive component of the battery according to an embodiment of the present application, respectively. As shown in FIGS. 7a and 7b, at least one of the first thermally conductive components 14 is U-shaped. Specifically, the U-shaped first thermally conductive component 14 includes a bottom surface 142, a first sidewall 144, and a second sidewall 146 opposite to the first sidewall 144. The first sidewall 144 and the second sidewall 146 extend from opposite two ends of the bottom surface 142. The U-shaped first thermally conductive component 14 is disposed on at least a portion of a first surface, a second surface, and at least a portion of a third surface of the respective cell 12, and the first surface, the second surface, and the third surface of the cell 12 are sequentially connected to each other. That is to say, the first sidewall 144 and the second sidewall 146 of the first thermally conductive component 14 are respectively disposed on at least a portion of the first surface and at least a portion of the third surface of the cell 12, and the bottom surface 142 of the first thermally conductive component 14 is disposed on a second surface of the battery 10. In an embodiment, with continued reference to FIG. 3, the first surface, the second surface and the third surface of the cell 12 may be respectively the first side surface 102 extending in the thickness direction T, the surface 104 extending in a width direction W, and the second side surface 106 opposite to the first side surface 102. In other embodiments, the second thermally conductive component 16 may constitute other surfaces of the cell 12. In an embodiment, in the thickness direction T, the lengths of the first side wall 144 and the second side wall 146 of the first thermally conductive component 14 are the same as the thickness of the cell 12, so that the first thermally conductive component 14 may be made to obtain a larger heat dissipation area.

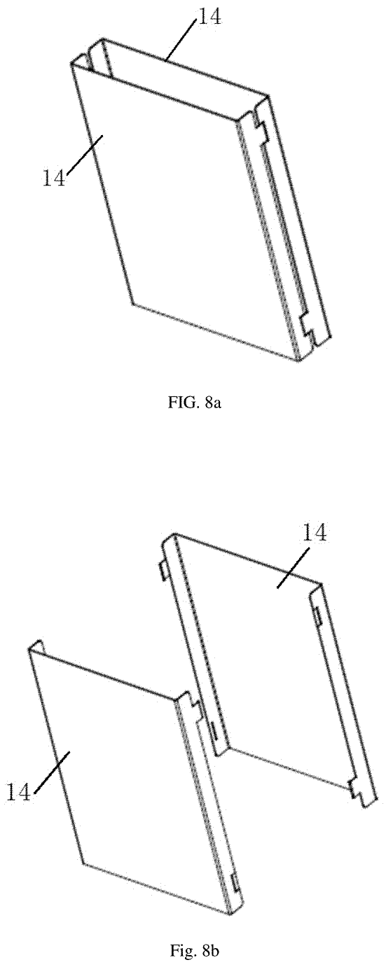

FIG. 8a shows a structural view of the first thermally conductive component of the battery according to another embodiment of the present application. FIG. 8b shows an exploded view of the first thermally conductive component of FIG. 8a. As shown in FIGS. 8a and 8b, two of the first thermally conductive components 14 are respectively arranged on surfaces of adjacent two of the cells, and the two of the first thermally conductive components 14 are all U-shaped, and the two of the first thermally conductive components 14 oppositely arranged and are engaged with each other, so that the adjacent two cells are disposed between the two first thermally conductive components 14 disposed opposite each other.

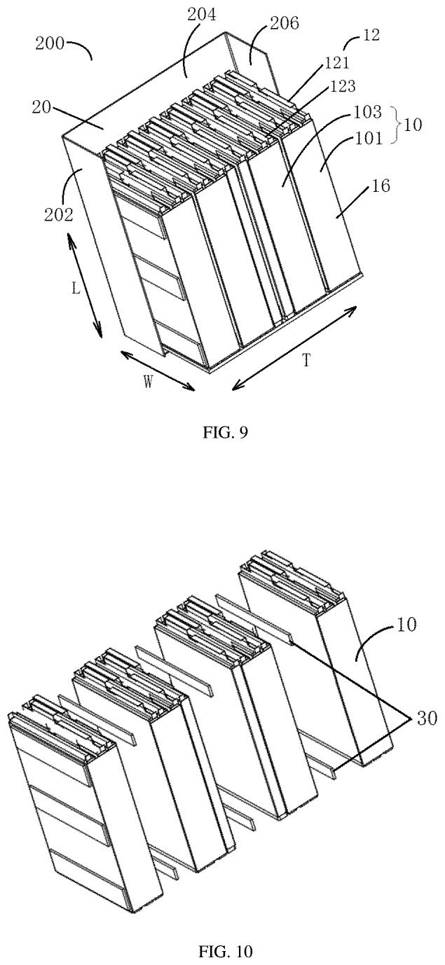

FIG. 9 shows a structural view of the battery pack according to an embodiment of the present application. As shown in FIG. 9, according to an embodiment of the present application, a battery pack 200 is provided, and the battery pack 200 comprises a plurality of batteries 10 above. And various embodiments of the battery 10 may be applied to the battery pack 200 without being limited. The battery pack 200 may further comprise a third thermally conductive component 20, and the third thermally conductive component 20 is in contact with the second thermally conductive component 16 of each battery 10. Since the third thermally conductive component 20 is in contact with the second thermally conductive component 16 of each of the batteries 10, heat may be transferred to the third thermally conductive component 20 through the second thermally conductive component 16, and heat may be dissipated through the third thermally conductive component 20. In some embodiments, the heat dissipation method for the third thermally conductive component 20 may be any one of heat dissipation methods such as natural heat dissipation, air cooling heat dissipation, and liquid cooling heat dissipation.

For the battery pack 200 provided by above technical solution of the present application, the heat conduction between the cell 12 at the edge of the battery pack 200 and the cell 12 at the center of the battery pack may be achieved by the heat transfer among the first thermally conductive component, the second thermally conductive component 16 and the third thermally conductive component 20, so as to reduce the heat concentration effect at the center of the battery pack when working and reduce the temperature difference between the cell 12 at the center and the cell 12 at the edge, causing the temperature between multiple cells 12 in the battery pack 200 more balanced, thereby improving the life of the battery pack. On the other hand, when assembling the battery pack, it can be assembled in units of each battery 10. Therefore, the battery pack 200 provided by the present application is more convenient to assemble, and may avoid the problems that assembly and movement are difficult due to the battery pack being too heavy during the assembly process.

In some embodiments, the battery 10 is divided into a first battery 101 and a second battery 103, and the first battery 101 is located outside the battery pack 200; the first battery 101 includes a plurality of first cells 121, and the second battery 103 includes a plurality of second cells 123, wherein the number of the plurality of first cells 121 of the first battery 101 may be different from the number of the plurality of second cells 123 of the second battery 103. In other embodiments, the number of the plurality of first cells 121 of the first battery 101 may be the same as the number of the plurality of second cells 123 of the second battery 103. The number of cells 12 in each battery 10 may be configured according to the heat transfer temperature difference of the cells in the thickness direction T of each of the cells 12 such that the temperature difference between each of the cells 10 in the battery pack 200 is minimized. Compared with the existing battery pack, the more the number of cells in the battery pack, the more excellent the effect of the battery pack provided by the present application. In particular, when the battery pack is charged and discharged at a large magnification, the effect of the battery pack of the present application may be further exhibited.

In an embodiment, with continued reference to FIG. 9, a plurality of batteries 10 are stacked in the thickness direction T. The number of batteries 10 shown in FIG. 9 is merely exemplary and the battery 10 in the battery pack 200 may be any other suitable number. In an embodiment, in the width direction W, a plurality of other batteries disposed in a stack may be provided. It should be understood that the plurality of batteries 10 in the battery pack 200 of the present application may be arranged in any suitable arrangement, which is not limited in this application.

In an embodiment, the battery pack 200 of the present application may further include a second thermally conductive adhesive disposed between the third thermally conductive component 20 and each second thermally conductive component 16. A distance of 1 mm to 2 mm is reserved between the third heat conducting component 20 and the plurality of batteries 10 to fill the second thermal conductive adhesive, so that the second thermal conductive adhesive has a thickness in the range of 1 mm to 2 mm, thereby ensuring the second thermal conductive adhesive can good contact with the third heat conducting member 20 and the plurality of batteries 10, and has a sufficient compression ratio.

In some embodiments, the second thermally conductive adhesive may include thermally conductive silica gel, one-component thermally conductive mud, and two-component thermally conductive gel. In an embodiment, the second thermally conductive adhesive may be made of a silicone rubber-based material, and filled with a highly thermally conductive metal oxide or other highly thermally conductive particles in the silicone rubber to simultaneously obtain the elasticity of the silicone rubber and the thermal conductivity of the filled particles.

In an embodiment, the third thermally conductive component 20 is U-shaped. The U-shaped third thermally conductive component 20 constitutes at least a portion of a first side surface 202, a second side surface 204, and at least a portion of a third side surface 206 of the battery pack 200, wherein the first side surface 202, the second side surface 204, and the third side surface 206 being sequentially connected to each other. In an embodiment, the first side surface 202, the second side surface 204 and the third side surface 206 of the battery pack 200 may be respectively the first side surface 202 extending in the width direction W, the second side surface 204 extending in the thickness direction T, and the third side surface 206 opposite to the first side surface 202. In other embodiments, the second thermally conductive component 16 may constitute other surfaces of the battery pack 200. In an embodiment, in the length direction L, the edge of the third thermally conductive component 20 exceeds the edge of the cell 12. In other embodiments, in the length direction L, the edge of the third thermally conductive component 20 may not exceed the edge of the cell 12. In some embodiments, the material of the third thermally conductive component 20 may be any suitable material that is advantageous for heat dissipation. For example, the material of the third thermally conductive component 20 includes any one of aluminum, stainless steel, and carbon steel.

FIG. 10 shows an exploded view of the plurality of batteries of the battery pack according to an embodiment of the present application. As shown in FIG. 10, the battery pack 200 may further comprise a second buffer sheet 30, and the second buffer sheet 30 is located between the plurality of batteries 10 to connect the adjacent two batteries 10 through the second buffer sheet 30. The second buffer sheet 30 may be fixedly connected to the corresponding battery 10 by providing an adhesive on the second buffer sheet 30. The second buffer sheet 30 may be a material having a cushioning effect such as foam. The connection between the batteries 10 is achieved by providing the second buffer sheet 30 between the adjacent two batteries 10, and an expansion space may be reserved for each of the soft-pack batteries.

The foregoing is only preferred exemplary embodiments of the present application and is not intended to be limiting of the present application, and any modifications, equivalent substitutions, improvements and the like within the spirit and principles of the present application are intended to be embraced by the protection range of the present application.

What is claimed is:

1. A battery, comprising:
a plurality of cells arranged in a stack;
a plurality of first thermally conductive components arranged on a surface of each cell; and
a second thermally conductive component constituting a portion of the surface of the battery, and each of the plurality of first thermally conductive components contacting the second thermally conductive component.

2. The battery according to claim 1, wherein the second thermally conductive component is U-shaped, the second thermally conductive component constitutes at least a portion of a first surface, a second surface, and at least a portion of a third surface of the battery, and the first surface, the second surface, and the third surface are sequentially connected to each other.

3. The battery according to claim 1, wherein the second thermally conductive component comprises a first thermally conductive sub-component and a second thermally conductive sub-component, and the first thermally conductive sub-component and the second thermally conductive sub-component are both L-shaped; and the first thermally conductive sub-component constitutes the first surface and a first portion of the second surface of the battery, and the second thermally conductive sub-component constitutes a second portion of the second surface and the third surface of the battery.

4. The battery according to claim 3, wherein the sum of areas of the first portion of the second surface and the second portion of the second surface is greater than or equal to 90% of an area of the second surface.

5. The battery according to claim 1, wherein at least one of the plurality of first thermally conductive components is U-shaped and located at least a portion of the first surface, the second surface, and at least a portion of the third surface of the respective cell, and the first surface, the second surface, and the third surface of the cell are sequentially connected to each other.

6. The battery according to claim 5, wherein two of the plurality of first thermally conductive components are respectively arranged on surfaces of adjacent two of the plurality of cells, and the two of the plurality of first thermally conductive components are arranged opposed to each other and are snapped each other.

7. The battery according to claim 1, further comprising a thermally conductive adhesive arranged between the second thermally conductive component and each of the plurality of first thermally conductive components.

8. The battery according to claim 1, wherein edges of the plurality of first thermally conductive components are aligned with each other in a length direction of the cell.

9. The battery according to claim 1, further comprising a buffer sheet located between adjacent two of the plurality of cells.

10. A battery pack, comprising a plurality of batteries and a third thermally conductive component, each battery comprising:
a plurality of cells arranged in a stack;
a plurality of first thermally conductive components arranged on a surface of each cell; and
a second thermally conductive component constituting a portion of the surface of the battery, and each of the plurality of first thermally conductive components contacting the second thermally conductive component;
wherein the third thermally conductive component contacts the second thermally conductive component.

11. The battery pack according to claim 10, wherein further comprising a second thermally conductive adhesive arranged between the third thermally conductive component and the second thermally conductive component.

12. The battery pack according to claim 10, wherein the plurality of batteries are stacked in a thickness direction of the battery.

13. The battery pack according to claim 12, wherein the third thermally conductive component is U-shaped, and the third thermally conductive component constitutes at least a portion of a first side surface, a second side surface, and at least a portion of a third side surface of the battery pack, wherein the first side surface, the second side surface, and the third side surface are sequentially connected to each other.

14. The battery pack according to claim 10, further comprising a second buffer sheet located between adjacent two of the plurality of batteries.

15. The battery pack according to claim 10, wherein the plurality of batteries is divided into a first battery and a second battery, and the first battery is at a side within the battery pack;
the first battery comprises a plurality of first cells, and the second battery comprises a plurality of second cells, wherein the number of the plurality of first cells is different from the number of the plurality of second cells.

16. The battery pack according to claim 10, wherein the second thermally conductive component is U-shaped, and the second thermally conductive component constitutes at least a portion of a first surface, a second surface, and at least a portion of a third surface of the battery, wherein the first surface, the second surface, and the third surface are sequentially connected to each other.

17. The battery pack according to claim 10, wherein the second thermally conductive component comprises a first thermally conductive sub-component and a second thermally conductive sub-component, wherein the first thermally conductive sub-component and the second thermally conductive sub-component are both L-shaped; the first thermally conductive sub-component constitutes the first surface and a first portion of the second surface of the battery, and the second thermally conductive sub-component constitutes a second portion of the second surface and the third surface of the battery.

18. The battery pack according to claim 17, wherein the sum of areas of the first portion of the second surface and the second portion of the second surface is greater than or equal to 90% of an area of the second surface.

19. The battery pack according to claim 10, wherein at least one of the plurality of first thermally conductive components is U-shaped and located at least a portion of the first surface, the second surface, and at least a portion of the third surface of the respective cell, wherein the first surface, the second surface, and the third surface of the cell are sequentially connected to each other.

20. The battery pack according to claim 19, wherein two of the first thermally conductive components are respectively arranged on surfaces of two adjacent ones of the cell, and the two of the first thermally conductive components are arranged as opposite to each other and are snapped each other.
